(19) United States
(12) Patent Application Publication
(10) Pub. No.: US 2024/0240336 A1
(43) Pub. Date: Jul. 18, 2024

(54) OXYFLUORIDES, ELECTRODES CONTAINING THEM AND THEIR USE FOR HYDROGEN PRODUCTION

(71) Applicants: UNIVERSITE DU MANS, LE MANS (FR); UNIVERSITE DE MONTREAL, MONTREAL (CA); CENTRE NATIONAL DE LA RECHERCHE SCIENTIFIQUE, Paris (FR)

(72) Inventors: Jérôme LHOSTE, LE MANS (FR); Nikolay KORNIENKO, Montreal (CA); Zahra GOHARIBAJESTANI, LONDON (GB); Vincent MAISONNEUVE, SOUILLÉ (FR); Amandine GUIET, LE MANS (FR); Annie RIBAUD, MONCÉ-EN-BELIN (FR); Romain MOURY, LE MANS (FR); Cyrille GALVEN, LE MANS (FR)

(21) Appl. No.: 18/558,590

(22) PCT Filed: May 6, 2022
(86) PCT No.: PCT/EP2022/062347

§ 371 Date: Nov. 2, 2023

(30) Foreign Application Priority Data
May 6, 2021 (EP) 21305587.4

(51) Int. Cl. C25B 11/077; C01G 51/00; C01G 53/00; C25B 1/04; C25B 11/052; C25B 11/065; H01M 4/90

(52) U.S. Cl. CPC C25B 11/0775; C01G 51/006; C01G 53/006; C25B 1/04; C25B 11/052; C25B 11/065; H01M 4/9016; H01M 4/9075; C01P 2002/50; C01P 2002/72; C01P 2002/82; C01P 2002/85; C01P 2002/88; C01P 2004/04; C01P 2006/40

(57) ABSTRACT

Oxyfluoride derivatives and their preparation, as well as their uses as catalysts in electrochemistry, including the electrodes and electrochemical cells comprising them. These may be useful for hydrogen production.

The present invention concerns the electrochemical production of hydrogen.

Global warming, ocean acidification, extreme weather events, and low air quality require an urgent energy transition towards renewable energies (wind, solar, thermal, etc.). However, their intermittent nature implies their storage. Hydrogen in tandem with a fuel cell (FC) appears among the most promising solution for energy storage and recovery, and some are already on the market. Although hydrogen is the most abundant gas in the universe, it is found on earth almost only in combined form (CH₄, H₂O . . . ). Steam methane reforming in which CO₂ is emitted is currently the main industrial process for hydrogen manufacturing (>95%). If CO₂ is not sequestered, this hydrogen is called gray hydrogen, if captured upstream, it is then qualified as blue hydrogen. In the long term, its production must tend towards greenhouse gas-free process to give decarbonized hydrogen called green hydrogen. The electrolysis of water falls under this last appellation and represents, in a vision of sustainable development, the most attractive solution. However, the industrial development of electrolyzers is hampered by their low energy efficiency, related to the need of a significant overpotential to the anode as illustrated in FIG. 1. Consequently, the cost of producing green hydrogen is four times higher than that of gray hydrogen.

According to the mechanisms proposed in the literature for the Oxygen Evolution Reaction (OER) reaction, the overpotential originates from the energy barriers of four intermediate reaction steps (Table 1). The addition of a catalyst lowers these barriers and thus the overpotential (FIG. 2). To date, the benchmark catalysts are iridium and ruthenium oxides, whether in acidic or basic medium. However, their prohibitive cost makes any industrial application difficult.

As an alternative to these benchmark oxides, new catalysts based on 3d elements have recently been proposed: ABO₃ perovskites, AB₂O₄ spinels and layer structures of mono- or multimetallic oxyhydroxides MOOH (Xu et al Chem. Soc. Rev 2017, 46, 337. https://doi.org/10.1039/c6cs00328a). This latter family provides currently the best alternative, in alkaline medium, to precious metal oxides but not industrialized.

Despite the aforementioned progress, there is still a need to continually push the performance of earth-abundant water oxidation catalysts.

According to a first object, the present invention thus concerns a compound of formula (I):

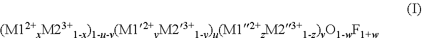

Wherein
M1, M2, M1′, M2′, M1″, M2″ are transition metals of the d/f block or alkaline-earth elements in the periodic table;
u, v, x, y and z are identical or different and are such that:
u+v<1;
0<x,y,z<1;
w=x+u(y−x)+v(z−x).

According to an embodiment, in formula (I):
M1, M2, M1′, M2′, M1″, M2″ are transition metals of the d/f block or alkaline-earth elements in the periodic table;
u, v, x, y and z are identical or different and are such that:
u+v<1;
0≤x,y,z≤1;
w=x+u(y−x)+v(z−x).

As used herein, the transition metals of the d/f block include the following elements:
3d : Sc, Ti, V, Cr, Mn, Fe, Co, Ni, Cu;
4d: Y, Zr, Nb, Mo, Tc, Ru, Rh, Pd, Ag;
5d: Lu, Hf, Ta, W, Re, Os, Ir, Pt, Au, Hg;
6d: Lr, Rf, Db, Sg, Bh, Hs, Mt, Ds, Rg, Cn; and
the lanthanides and actinides of the f block, which include La, Ce, Pr, Nd, Pm, Sm, Eu, Gd, Tb, Dy, Ho, Er, Tm, Yb, Ac, Th, Pa, U, Np, Pu, Am, Cm, Bk, Cf, Es, Fm, Md, No.

Alkaline-earth elements refer to Be, Mg, Ca, Sr, Ba, Ra.

According to an embodiment, M1, M1′ and M1″ belong to d/f block or alkaline-earth elements in the periodic table and M2, M2′ and M2″ belong to d/f block of the periodic table.

In particular, M1 and M1′, M1″ are chosen from Mn, Fe, Co, Ni, Cu, Zn and M2 and, M2′, M2″ are chosen from Mn, Fe, Co, Ni, Ru, Rh.

According to an embodiment, either x=0.5 and y=z=u=v=0 or
x=y=0.5 and u=0.5 and z=v=0 with M2=M2′ or
x=0.3 and y=0.7 and u=0.5 and z=v=0 with M2=M2′.

According to a particular embodiment, the compound of formula (I) is chosen from the following compounds:
M²⁺_{0.5}Fe³⁺_{0.5}O_{0.5}F_{1.5} with M=Co, Ni, Zn
Co²⁺_{0.5}Fe³⁺_{0.5}O_{0.5}F_{1.5}
Co²⁺_{0.75}Fe³⁺_{0.25}O_{0.25}F_{1.75}
Ni²⁺_{0.5}Fe³⁺_{0.5}O_{0.5}F_{1.5},
Zn²⁺_{0.5}Fe³⁺_{0.5}O_{0.5}F_{1.5},
Co²⁺_{0.25}Ni²⁺_{0.25}Fe³⁺_{0.5}O_{0.5}F_{1.5},
Ni²⁺_{0.15}Co²⁺_{0.425}Fe³⁺_{0.425}O_{0.425}F_{1.575},
Ni²⁺_{0.25}Co²⁺_{0.375}Fe³⁺_{0.375}O_{0.375}F_{1.625},
Ni²⁺_{0.5}Co²⁺_{0.25}Fe³⁺_{0.25}O_{0.25}F_{1.75},
Ni²⁺_{0.75}Co²⁺_{0.125}Fe³⁺_{0.125}O_{0.125}F_{1.875} and
Co²⁺_{0.15}Fe²⁺_{0.35}Fe³⁺_{0.5}O_{0.5}F_{1.5}.

According to a further object, the present invention concerns a solid solution of the compound of formula (I) as defined above.

The term “solid solution” as used herein refers to a unique phase component made of the compound of formula (I) as defined above.

According to a still further object, the present invention concerns an electrode comprising the compound of the invention, as a catalyst.

As a catalyst, the compounds of formula (I) lower the kinetics barrier of the intermediates reactions involved in water electrolysis. Some illustrative reactions are set out in Table 1 below:

TABLE 1
Intermediates reactions during OER in acidic or basic media.

| Acid catalyst | | Alkaline catalyst | |
|---|---|---|---|
| H₂O + * → HO* + H⁺ + e⁻ | 1A) | OH⁻ + * → HO* + e⁻ | 1B) |
| HO* → O* + H⁺ + e⁻ | 2A) | HO* + OH⁻ → O* + H₂O + e⁻ | 2B) |
| H₂O + O* → HOO* + H⁺ + e⁻ | 3A) | O* + OH⁻ → HOO* + e⁻ | 3B) |
| HOO* → * + O₂ + H⁺ + e⁻ | 4A) | HOO* + OH⁻ → * + O₂ + H₂O + e⁻ | 4B) |

The symbol * means the active site of the catalyst.

According to an embodiment, said electrode may be a working, a positive or a negative electrode.

Typically, the electrode comprises a support loaded with said catalyst.

Said support is generally chosen from stable, inert high-surface area substrates which are able to load the catalyst.

The loading may be achieved in particular by impregnating the support with an ink comprising the catalyst compound (I). Typically, the support may be soaked in the ink or spread with the ink.

Said ink may be a mixture of the catalyst compound (I) in an aqueous solution, optionally comprising a water soluble solvent (such as ethanol). Said ink may also comprise one or more binders, such as Nafion and multiwalled carbon nanotubes. The CNT helps electrically connect the catalyst and the Nation helps with adhesion to the substrate.

Said support may be chosen in particular from carbon paper (such as Toray carbon paper), Ni foam, transparent conductive oxides (TCO) such as fluorinated tin oxide (Fluorine doped tin oxide, FTO), indium tin oxide (ITO) and antimony doped tin oxide (ATO).

The catalyst loaded support located on one side of the electrode contacts with the electrolyte whereas the other side of the electrode is connected with a current collector.

According to another object, the present invention also concerns a process of preparation of the solid solution of the invention. Said process comprises the following steps:
The synthesis of a hydrated fluorinated precursor of formula (II):

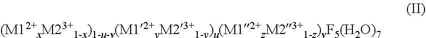

Where x, y, z, u, v, M1, M2, M1′, M2′, M1″ and M2″ are defined as above,
By evaporation of a concentrated hydrofluoric acid (HF) solution of the dissolved metal salts or by precipitation of said solution; and
The thermal treatment of the compound of formula (II) at a temperature comprised between 150 and 400° C.

The concentrated hydrofluoric acid (HF) solution is a solution of hydrogen fluoride in water, in a concentration comprised between 20 and 40 mol·L⁻¹, typically 28 mol·L⁻¹ (HF_{48%}).

The solution of dissolved metal salts refers to the concentrated hydrofluoric acid solution wherein salts of M1, M2, M1′, M2′, M1″, M2″ as well as their counter-ions are dissolved. Counter-ions may include anions such as chloride, nitrate, carbonate, phosphate, sulfate, acetate, carbonate, etc . . . . Such solution of dissolved metal salts can be achieved by dissolving under stirring salts of M1, M2, M1′, M2′, M1″, M2″with their respective counter ions, or solvates therefrom in the concentrated hydrofluoric acid solution, in respective concentrations corresponding to the respective ratio of M1, M2, M1′, M2′, M1″, M2″ in formula (II).

The evaporation may be conducted by stirring the solution under heating (generally in an oil bath) at a temperature below or equal to the boiling temperature of the solution, typically at about 100° C. for a duration sufficient to achieve a precipitate.

Alternatively, the precipitate may be obtained by the precipitation of the solution of concentrated hydrofluoric acid (HF) of the dissolved metal salts, by addition of alcohol, typically ethanol. Said precipitation may be handled at room temperature.

According to both alternatives, the precipitate is then separated e.g. by filtration. Said precipitate is constituted by the hydrated fluorinated compound (II).

The step of thermal treatment may be carried out in a furnace at a temperature comprised between 150 and 400° C., generally under ambient atmosphere, in a duration sufficient to achieve the weight loss corresponding of the loss of the six water and two HF molecules comprised in the hydrated fluorinated precursor of formula (II).

The compounds of formula (II) are novel and are another object of the invention:

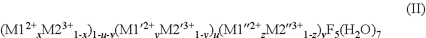

Where x, y, z, u, v, M1, M2, M1′, M2′, M1″ and M2″ are defined as above.

According to another object, the invention also concerns an electrochemical cell comprising at least one electrode of the invention.

Typically, said electrochemical cell may be a water electrolyzer and/or a fuel cell.

In the case of electrolysis, the electrode of the invention is typically a working electrode (i.e.) the electrode on which the reaction of interest (water electrolysis) occurs.

The working electrode is typically used in three electrode system, in conjunction with an auxiliary electrode (Pt or carbon counter electrode) and a reference electrode (such as Hg/HgO reference electrode).

The electrolyte may generally be chosen from strong acids such as sulfuric acid and strong bases such as potassium hydroxide and sodium hydroxide, due to their strong conducting abilities. A solid polymer electrolyte such as Nafion can also be used.

Fuel cells are made up of an anode and a cathode separated by an electrolyte.

The electrolyte can be chosen from potassium hydroxide, salt carbonates, and phosphoric acid or can be a polymer membrane in particular.

According to another object, the present invention also concerns a process of preparation of hydrogen comprising the electrolysis of water with an electrochemical cell of the invention.

Water electrolysis (also called water splitting) refers to the process of using electricity to decompose water into oxygen and hydrogen gas, requiring a minimum potential difference of 1.23 volts.

Hydrogen gas formed in this way can be used as hydrogen fuel in a fuel cell combined with said water electrolyzer.

In the fuel cell, hydrogen is consumed, water is created, and an electric current is generated, which can be used to power electrical devices.

The following reactions are involved (Table 2):

| Electrolyte | Water electrolysis | Fuel cell |
|---|---|---|
| Acidic solution | Cathode: 2H⁺ + 2e⁻ → H₂ (0 V) | Cathode: H₂ → 2H⁺ + 2e⁻ (0 V) |
| | $Anode : {H}_{2} O \to 2 {H}^{+} + \frac{1}{2} {O}_{2} + 2 {e}^{-} ( 1.23 V )$ | $Anode : 2 {H}^{+} + \frac{1}{2} {O}_{2} + 2 {e}^{-} \to {H}_{2} O ( 1.23 V )$ |
| Alkaline solution | Cathode: 2H₂O + 2e⁻ → H₂ + 2OH⁻ (0 V) | Cathode: H₂ + 2OH⁻ → 2H₂O + 2e⁻ (0 V) |
| | $Anode : 2 {OH}^{-} \to {H}_{2} O + \frac{1}{2} {O}_{2} + 2 {e}^{-} ( 1.23 V )$ | $Anode : {H}_{2} O + \frac{1}{2} {O}_{2} + 2 {e}^{-} \to 2 {OH}^{-} ( 1.23 V )$ |

### FIGURES

FIG. 1 is a schematic representation of an electrolyzer (A) and representation of overpotential applied to the anode at 10 mA·cm⁻² (B).

FIG. 2 is a representation of modulating the energy levels of the binding strength between the active sites and the intermediates and its impact on the overpotential.

FIG. 3 represents the cyclic voltammetry measurement of Co²⁺_{0.5}Fe³⁺_{0.5}O_{0.5}F_{1.5} showing the current density as a function of the potential applied.

FIG. 4 illustrates the Tafel slope of Co²⁺_{0.5}Fe³⁺_{0.5}O_{0.5}F_{1.5} on Glassy Carbon and Carbon Paper substrate indicating that for every increase of 27 mV of applied potential, the current density increases by one order of magnitude.

FIG. 5 shows the evolution of the mass activity (left) and TOF (right) as a function of the applied potential for Co²⁺_{0.5}Fe³⁺_{0.5}O_{0.5}F_{1.5}.

FIG. 6 represents the Arrhenius plot for Co²⁺_{0.5}Fe³⁺_{0.5}O_{0.5}F_{1.5} to determine the activation energy of the rate limiting step.

FIG. 7 illustrates the chronopotentiometric measurement of Co²⁺_{0.5}Fe³⁺_{0.5}O_{0.5}F_{1.5} over extended periods of time shows no obvious activity decrease.

FIG. 8 represents the XRD patterns of Co²⁺Fe³⁺F₅(H₂O)₇, Ni²⁺Fe³⁺F₅(H₂O)₇ and Co²⁺_{0.5}Ni²⁺_{0.5}Fe³⁺F₅(H₂O)₇ matching with the PDF card number 00-037-0794 (CoFeF₅(H₂O)₇).

FIG. 9 represents the XRD patterns of Co²⁺_{0.75}Fe²⁺_{0.25}F₂(H₂O)₄ and Co²⁺_{0.25}Ni²⁺_{0.5}Fe²⁺_{0.25}F₂(H₂O)₄ matching with the PDF card number 00-025-0243 (CoF₂(H₂O)₄)

FIG. 10 represents the volume of the cell as a function of the composition for Co²⁺ₓFe²⁺₁₋ₓF₂(H₂O)₄ with x=0-1. The evolution is in accordance to the Vegard's law which confirms the metal ratio.

FIG. 11 represents the volume of the cell as a function of the composition for NiₓCo²⁺_{(1-x)/2}Fe²⁺_{(1-x)/2}F₂(H₂O)₄, with x=0-1. The evolution is in accordance to the Vegard's law which confirms the metal ratio.

FIG. 12 represents the EDX spectra of Co²⁺Fe³⁺F₅(H₂O)₇ and Ni²⁺Fe³⁺F₅(H₂O)₇, ratios of metal cations M′³⁺/M²⁺ are close to one.

FIG. 13 represents the TXRD of Co²⁺Fe³⁺F₅(H₂O)₇ under ambient atmosphere showing the formation of the intermediate phase Co²⁺_{0.5}Fe³⁺_{0.5}O_{0.5}F_{1.5} with rutile structure type (characteristic peaks surrounded in the black circles).

FIG. 14 represents the thermogravimetric curve of Co²⁺Fe³⁺F₅(H₂O)₇ under ambient air.

FIG. 15 represents the XRD patterns of Co²⁺_{0.5}Fe³⁺_{0.5}O_{0.5}F_{1.5} and Ni²⁺_{0.5}Fe³⁺_{0.5}O_{0.5}F_{1.5} obtained by thermal treatment of Co²⁺Fe³⁺F₅(H₂O)₇ and Ni²⁺Fe³⁺F₅(H₂O)₇, respectively.

FIG. 16 illustrates the comparison of FTIR spectra of Co²⁺_{0.5}Fe³⁺_{0.5}O_{0.5}F_{1.5} and Ni²⁺_{0.5}Fe³⁺_{0.5}O_{0.5}F_{1.5} with those of their corresponding hydrated precursors, Co²⁺Fe³⁺F₅(H₂O)₇ and Ni²⁺Fe³⁺F₅(H₂O)₇.

FIG. 17 represents the N₂ adsorption-desorption isotherms of Co²⁺_{0.5}Fe³⁺_{0.5}O_{0.5}F_{1.5} and Ni²⁺_{0.5}Fe³⁺_{0.5}O_{0.5}F_{1.5} and corresponding BJH pore size distributions.

FIG. 18 represents the TEM pictures showing the mesoporosity of Co²⁺_{0.5}Fe³⁺_{0.5}O_{0.5}F_{1.5} and Ni²⁺_{0.5}Fe³⁺_{0.5}O_{0.5}F_{1.5}.

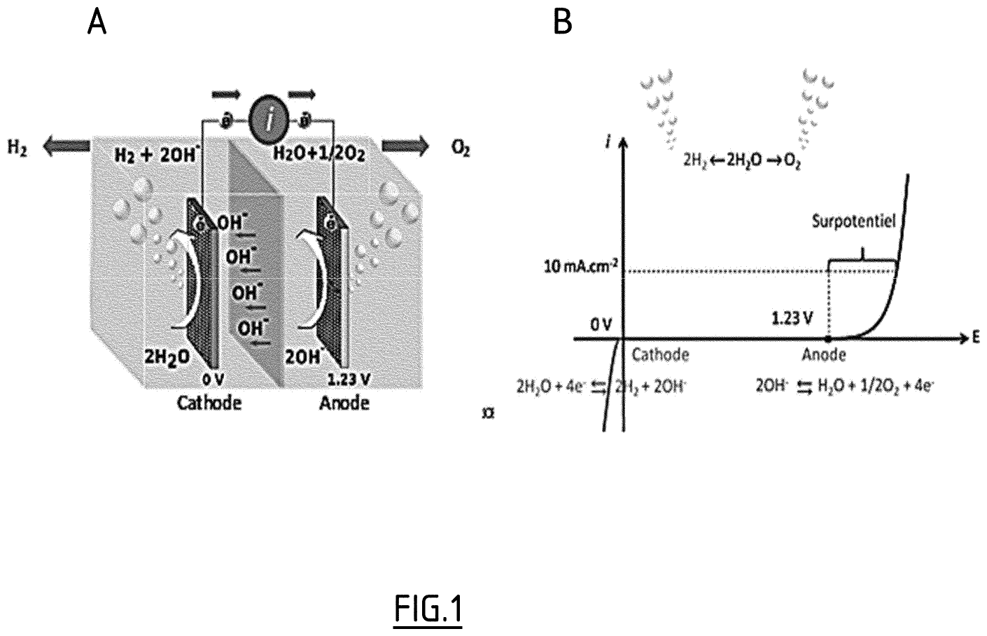

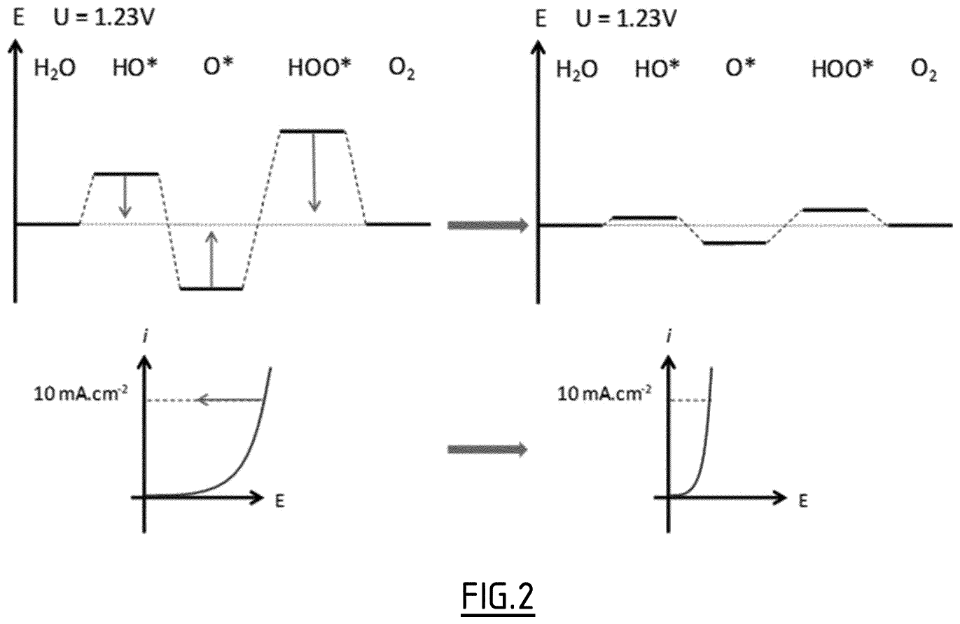

### EXAMPLES

### Example 1: Electrocatalytic Properties of Solid Solutions M²⁺ₓM³⁺₁₋ₓO₁₋ₓF₁₊ₓ

Electrocatalytic measurements are performed in a standard 3-electrode setup in a custom-built glass single compartment reaction cell. Hg/HgO reference and Pt or carbon counter electrodes are used for all measurements. For a working electrode substrate, Toray Carbon Paper is used as a model high-surface area support (catalyst loading of 5 mg·cm⁻²). Alternatively, a rotating disk setup with a glassy carbon surface is used (catalyst loading of 0.1 mg·cm⁻²). To generate a catalyst-coated working electrode, a catalyst ink is generated by sonicating 300 μl ethanol, 100 μl de-ionized water, 10 μl of 5% Nafion™ solution, 4 mg catalyst and 0.2 mg multiwalled carbon nanotubes (10-40 nm diameter). The ink is spread onto a working electrode surface and allowed to dry under ambient conditions. 1.0 M KOH is used as the electrolyte in all measurements at room temperature (approximately 21° C.) and 95% compensation of the solution resistance is used correct correction. The solution resistance is measured at open circuit at 100 KHz frequency before each measurement. Turnover frequencies (TOFs) are calculated by dividing the reaction rate (extracted from the current density, assuming 4 electrons extracted from each water molecule) by the redox-active cobalt species, calculated through integrating the area under the Co(II/III) redox peak at 0.1 V vs. RHE (Reversible Hydrogen Electrode).

### Example of Co²⁺_{0.5}Fe³⁺_{0.5}O_{0.5}F_{1.5}

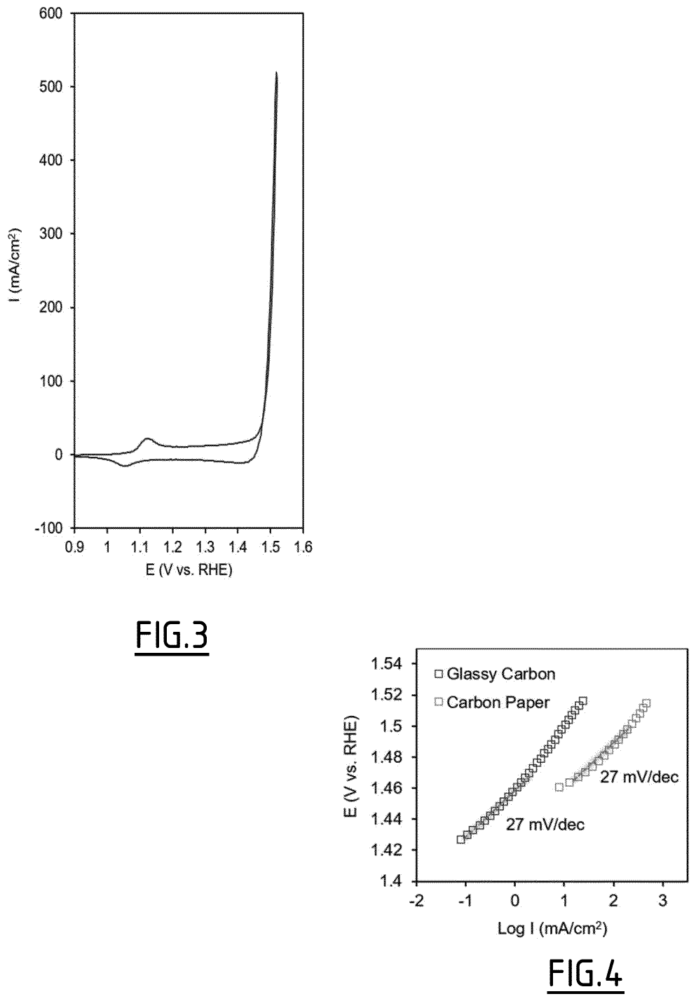

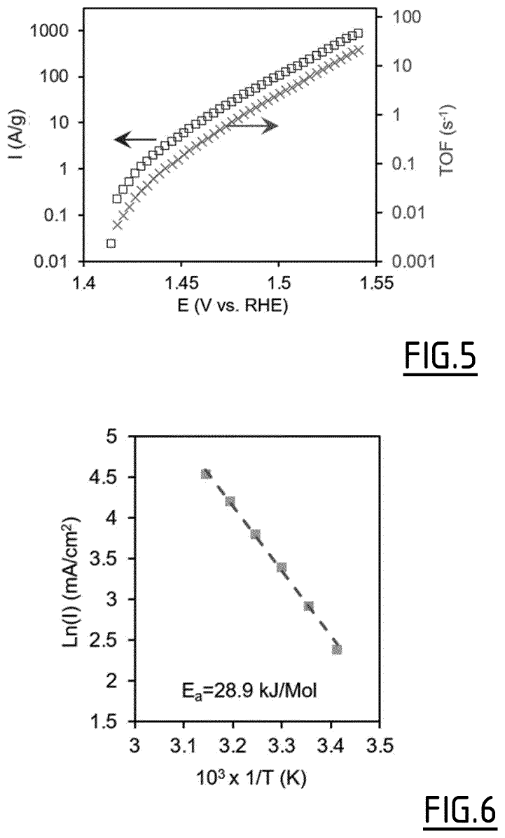

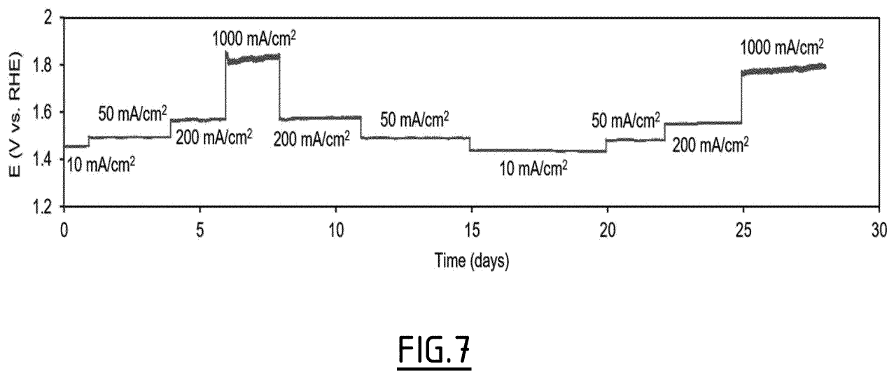

The Co²⁺_{0.5}Fe³⁺_{0.5}O_{0.5}F_{1.5} catalyst-loaded carbon paper electrode exhibits 220 mV overpotential for a current density of 10 mA·cm⁻² (FIG. 3). The Tafel slope, measured in a current density range of 1-100 mA·cm⁻², is calculated to be 27 mV·decade⁻¹ (FIG. 4). At 300 mV overpotential, the mass activity of Co²⁺_{0.5}Fe³⁺_{0.5}O_{0.5}F_{1.5} reaches 846 A·g⁻¹, with a TOF of 21 s⁻¹ per electroactive site (or 0.5 s⁻¹ using the total mass of cobalt deposited) (FIG. 5). The high activity is also evident through the low activation energy of 28.9 KJ·mol⁻¹, calculated from the Arrhenius plot (FIG. 6). The activity is stable for more than 500 h, as measured through chronopotentiometric tests at current densities of 10, 50, 200 and 1000 mA·cm⁻² (FIG. 7).

Overall, the electrocatalytic performance of Co²⁺_{0.5}Fe³⁺_{0.5}O_{0.5}F_{1.5} is arguably the best reported for a cobalt-based material under the above-mentioned standard testing conditions in terms of a combination of overpotential, mass activity, turnover frequency and stability. This conclusion is attained after a careful comparison of quantitative performance metrics of notable catalysts reported over the last several years (Table 3).

Table 3 gathers their electrochemical properties in comparison with precious metals oxides and with the best reported oxohydroxides. It should be noted that in order to properly compare catalytic performances of anodic materials, it is necessary to take into account several electrochemical characteristics as well as the measuring conditions:
overpotential (mV),
Tafel slope (mV·dec⁻¹): the lower it is, the lower the increase in potential to be applied to obtain a high current density and therefore a high hydrogen production rate,
turnover frequency (TOF, s⁻¹): reflects the efficiency of a catalytic site (frequency of reactions). The higher the TOF, the better the activity,
mass activity (mA·g⁻¹) at a given overpotential,
temperature of the electrolytic medium, here RT,
concentration of the medium in KOH, here 1 M.

TABLE 3
Electrochemical characteristics of best catalysts in literature, LDH stand for Layer
Double Hydroxide, G for Gelled, CP for Carbon Paper and GC for Glassy Carbon.

| | | | | | Mass | |
|---|---|---|---|---|---|---|
| | | | Bulk TOF | Tafel | activity** | |
| Catalysts | Substrate | η* (mV) | (s⁻¹)** | (mV · dec⁻¹) | (A · g⁻¹) | Reference |
| Co_{0.5}Fe_{0.5}O_{0.5}F_{1.5} | CP | 220 | 0.5 | 27 | 846 | Present |
| | | | | | | invention |
| LDH-(Co,Fe) | CP | 331 | 0.01 | 85 | 32 | Zhang et [symbol] |
| | | | | | | Science (8 [symbol] |
| | | | | | | 2016, 3 [symbol] |
| | | | | | | (6283), 333 [symbol] |
| | | | | | | 337. |
| G-(Co,Fe)OOH | GC | 271 | 0.043 | 60 | 162 | Zhang et [symbol] |
| | | | | | | 2016 |
| G- | CP | 233 | 0.09 | — | — | Zhang et al. N [symbol] |
| (Co,Fe,Mo)OOH | | | | | | Catal. 2020, [symbol] |
| | | | | | | 985-9924 |
| G- | CP | 212 | 0.24 | — | — | Zhang et [symbol] |
| (Co,Fe,Mo,W)OOH | | | | | | 2020 |
| G- | GC | 217 | 0.46 | 37 | 1175 | Zhang et [symbol] |
| (Co,Fe,W)OOH | | | | | | 2016 |
| LDH-(Ni,Fe) | GC | 269 | 0.07 | — | 117 | Zhang et [symbol] |
| | | | | | | 2016 |
| LDH/GO-(Ni,Fe) | GC | 210 | 0.1 | 42 | — | McCrory et al. |
| | | | | | | Am. Chem. So [symbol] |
| | | | | | | 2015, 137 (13 [symbol] |
| | | | | | | 4347-4357 |
| (Ni,Fe,Mo)OOH | CP | 201 | 0.1 | 32 | — | Zhang et [symbol] |
| | | | | | | 2020 |
| (Ni,Fe,Mo,W)OOH | CP | 205 | 0.14 | 28 | — | Zhang et [symbol] |
| | | | | | | 2020 |
| IrO₂ | CP | 260 | 0.01 | 45 | — | McCrory et [symbol] |
| | | | | | | 2015 |

*evaluated at 10 mA · cm⁻²
**evaluated at 300 mV [symbol]
indicates data missing or illegible when filed

### Example 2: Synthesis of M²⁺M′³⁺F₅(H₂O)₇ and M²⁺ₓM′²⁺₁₋ₓF₂(H₂O)₄

The synthesis of oxyfluorinated solid solutions M²⁺ₓM′³⁺₁₋ₓO₁₋ₓF₁₊ₓ is carried out in two steps: the first one is the synthesis of a hydrated fluorinated precursor M²⁺M′³⁺F₅(H₂O)₇, frequently written MM′F₅.7H₂O, or M²⁺ₓM′²⁺₁₋ₓF₂(H₂O)₄ in concentrated hydrofluoric acid (HF) and the second one consists of a moderate thermal treatment in ambient atmosphere to obtain the solid solutions M²⁺ₓM′³⁺₁₋ₓO₁₋ₓF₁₊ₓ.

For the synthesis of MM′F₅.7H₂O: The metal salts (chlorides, nitrates, carbonates, phosphates, sulfates, acetates . . . ) are dissolved in a concentrated HF solution. Then the solution is evaporated at a temperature below the boiling point of the solution until the beginning of the precipitation. The solution is cooled at ambient air and the as-synthesized solid is filtered out, washed and dried leading to MM′F₅(H₂O)₇ with a yield around 70%. These synthesis methods can be extending to three (or more) metals by multi-substitution as well as on +II and/or +III metal cations such as M²⁺₁₋ₓM″²⁺ₓM′³⁺F₅(H₂O)₇ or M²⁺M′³⁺₁₋ₓM″³⁺ₓF₅(H₂O)₇. As alternative synthesis, after dissolution of the metal salts, the precipitation is triggered by an addition of an alcohol such as ethanol at room temperature. The solid is recovered by the same aforementioned protocol.

For the synthesis of M²⁺ₓM′²⁺₁₋ₓF₂(H₂O)₄: the metal salts (chlorides, nitrates, carbonates, phosphates, sulfates, acetates ...) are dissolved in alcohol (ethanol, isopropanol, . . . ). The solvent should be degassed prior to the reaction by bubbling it with argon for 30 min. After the degassed concentrated HF (bubbling with argon for 30 min) is added allowing the hydrated fluoride to precipitate. The as-synthesized solid is filtered out, washed and dried leading to MM′F₂(H₂O)₄ with a yield around 70%. These synthesis methods can be extending to three (or more) metals by multi-substitution such as M²⁺₁₋ₓM″²⁺ₓM′²⁺F₂(H₂O)₄.

### Example 2.1: Co²⁺Fe³⁺F₅(H₂O)₇

CoCl₂.6H₂O (237.9 mg) and Fe(NO₃)₃.9H₂O (404.0 mg) are dissolved into 10 ml of a concentrated hydrofluoric acid solution (28 mol·L⁻¹, HF_{48%}). The reaction mixture is placed in a Teflon Becher and stirred for 1 h at 100° C. in an oil bath until the formation of a precipitate. After cooling, the mixture is filtered, washed with technical ethanol and dried at room temperature giving pink powder.

### Example 2.2: Ni²⁺Fe³⁺F₅(H₂O)₇

Ni(NO₃)₂.6H₂O (290.8 mg) and Fe(NO₃)₃.9H₂O (404.0 mg) are dissolved into 10 mL a concentrated hydrofluoric acid solution (28 mol·L⁻¹, HF_{48%}). The reaction mixture is placed in a Teflon Becher and stirred for 1 h at 100° C. in an oil bath until the formation of a precipitate. After cooling, the mixture is filtered, washed with technical ethanol and dried at room temperature giving green powder.

### Example 2.3: Co²⁺_{0.5}Ni²⁺_{0.5}Fe³⁺F₅(H₂O)₇

CoCl₂.6H₂O (119.0 mg), Ni(NO₃)₂.6H₂O (145.4 mg) and Fe(NO₃)₃.9H₂O (404.0 mg), are dissolved into 10 mL a concentrated hydrofluoric acid solution (28 mol·L⁻¹, HF_{48%}). The reaction mixture is placed in a Teflon Becher and stirred for 1 h at 100° C. in an oil bath until the formation of a precipitate. After cooling, the mixture is filtered, washed with technical ethanol and dried at room temperature giving brownish powder.

### Example 2.4: Co²⁺_{0.75}Fe²⁺_{0.25}F₂(H₂O)₄

CoCl₂.6H₂O (892.2 mg), and FeCl₂.4H₂O (248.5 mg), are dissolved into 50 ml of isopropanol. The latter has been, prior to the synthesis, carefully degassed by bubbling it using argon for 30 min. The reaction mixture is placed in a round bottom flask previously flushed with argon. Once the solubilisation is completed, 10 mL of degassed concentrated hydrofluoric acid solution (28 mol·L⁻¹, HF_{48%}) (30 minute by bubbling it using argon) is added to the solution and the solution is allowed to stir for 30 min under argon atmosphere until precipitation is complete. Finally, the mixture is filtered, washed with technical ethanol and dried at room temperature giving a pink powder.

### Example 2.5: Co²⁺_{0.25}Ni²⁺_{0.5}Fe²⁺_{0.25}F₂(H₂O)₄

CoCl₂.6H₂O (119 mg), Ni(NO₃)₃.6H₂O (290.8 mg) and FeCl₂.4H₂O (99.8 mg), are dissolved into 15 mL of isopropanol. The latter has been, prior to the synthesis, carefully degassed by bubbling it using argon for 30 min. The reaction mixture is placed in a round bottom flask previously flushed with argon. Once the solubilisation is completed, 3 mL of degassed concentrated hydrofluoric acid solution (28 mol·L⁻¹, HF_{48%}) (30 minute by bubbling it using argon) is added to the solution and the solution is allowed to stir for 30 min under argon atmosphere until precipitation is complete. Finally, the mixture is filtered, washed with technical ethanol and dried at room temperature giving a brownish powder.

### Example 3: Synthesis of Solid Solutions M²⁺ₓM′³⁺₁₋ₓO₁₋ₓF₁₊ₓ

A thermal treatment at moderated temperature (+/−250° C.) in atmospheric conditions of hydrated fluorides MM′F₅(H₂O)₇ leads to the formation of solid solutions M_{0.5}M′_{0.5}O_{0.5}F_{1.5} along the general reaction:

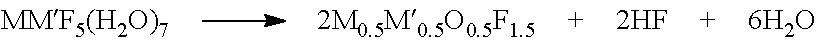

### Example 3.1: Co²⁺_{0.5}Fe³⁺_{0.5}O_{0.5}F_{1.5}

Co²⁺_{0.5}Fe³⁺_{0.5}O_{0.5}F_{1.5} is obtained by thermal treatment of Co²⁺Fe³⁺F₅(H₂O)₇ under ambient atmosphere at 240° C. for 1 h in a furnace corresponding to an experimental weight loss of 43.4% close to the theoretical value 43.9% (m_{before}=175 mg, m_{after}=99 mg).

### Example 3.2: Ni²⁺_{0.5}Fe³⁺_{0.5}O_{0.5}F_{1.5}

Ni²⁺_{0.5}Fe³⁺_{0.5}O_{0.5}F_{1.5} is obtained by thermal treatment of Ni²⁺Fe³⁺F₅(H₂O)₇ under ambient atmosphere at 290° C. for 1 h 30 min in a furnace corresponding to an experimental weight loss of 44.7% close to the theoretical value 44% (m_{before}=434 mg, m_{after}=240 mg).

### Example 3.3: Co²⁺_{0.25}Ni²⁺_{0.25}Fe³⁺_{0.5}O_{0.5}F_{1.5}

Co²⁺_{0.25}Ni²⁺_{0.25}Fe³⁺_{0.5}O_{0.5}F_{1.5} is obtained by thermal treatment of Co²⁺_{0.5}Ni²⁺_{0.5}Fe³⁺F₅(H₂O)₇ under ambient atmosphere at 280° C. for 30 min in a furnace corresponding to an experimental weight loss of 46% close to the theoretical value 44.0% (m_{before}=371 mg, m_{after}=200 mg).

### Example 3.4: Co²⁺_{0.75}Fe³⁺_{0.25}O_{0.25}F_{1.75}

Co²⁺_{0.75}Fe³⁺_{0.25}O_{0.25}F_{1.75} is obtained by thermal treatment of Co²⁺_{0.75}Fe²⁺_{0.25}F₂(H₂O)₄ under dry synthetic air at 300° C. for 1 h in a furnace previously flushed for 30 min under dry synthetic air, corresponding to an experimental weight loss of 41.5% close to the theoretical value 43.7% (m_{before}=436 mg, m_{after}=255 mg).

### Example 3.5: Co²⁺_{0.25}Ni²⁺_{0.5}Fe³⁺_{0.25}O_{0.25}F_{1.75}

Co²⁺_{0.25}Ni²⁺_{0.5}Fe³⁺_{0.25}O_{0.5}F_{1.5} is obtained by thermal treatment of Co²⁺_{0.25}Ni²⁺_{0.5}Fe²⁺_{0.25}F₂(H₂O)₄ under dry synthetic air at 220° C. for 1 h in a furnace previously flushed for 30 min under dry synthetic air, corresponding to an experimental weight loss of 39.1% close to the theoretical value 40.2% (m_{before}=139.5 mg, m_{after}=85 mg).

### Example 4: Characterization of M²⁺M′³⁺F₅(H₂O)₇ and M²⁺ₓM′³⁺₁₋ₓO₁₋ₓF₁₊ₓ

XRD=X-ray diffraction
SEM-EDX=Scanning Electron Microscope coupled with Energy Dispersive X-ray
TXRD=Thermal X-ray Diffraction
TGA=ThermoGravimetry Analysis
FTIR=Fourier Transformed Infrared Spectroscopy
TEM=Transmission Electron Microscopy

### Example 4.1: Characterization of M²⁺M′³⁺F₅(H₂O)₇

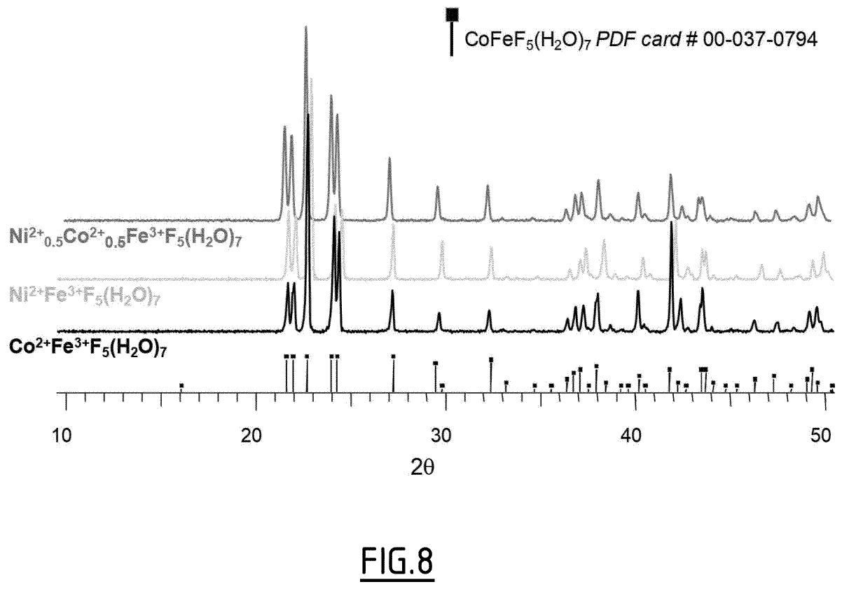

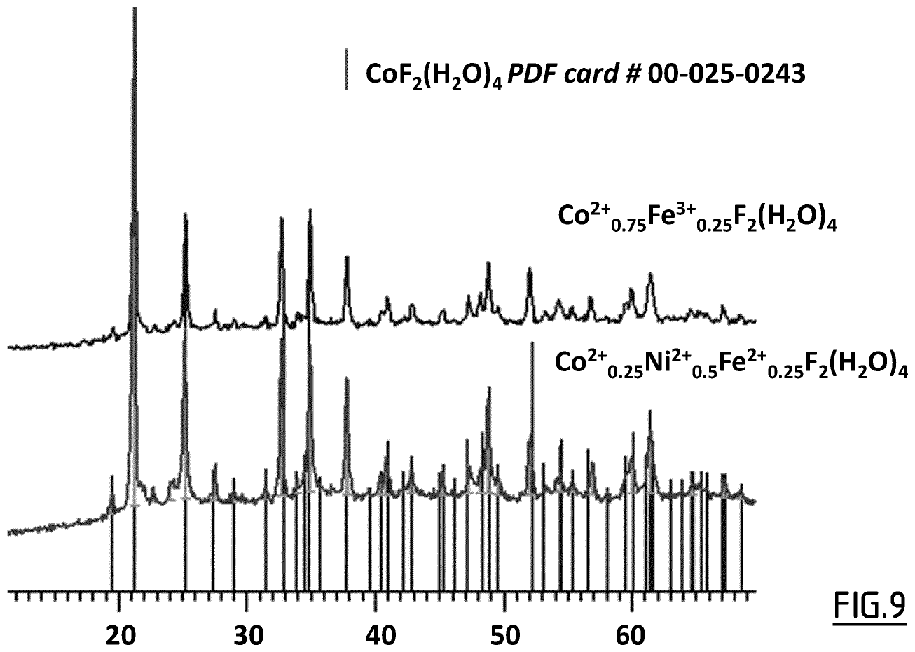

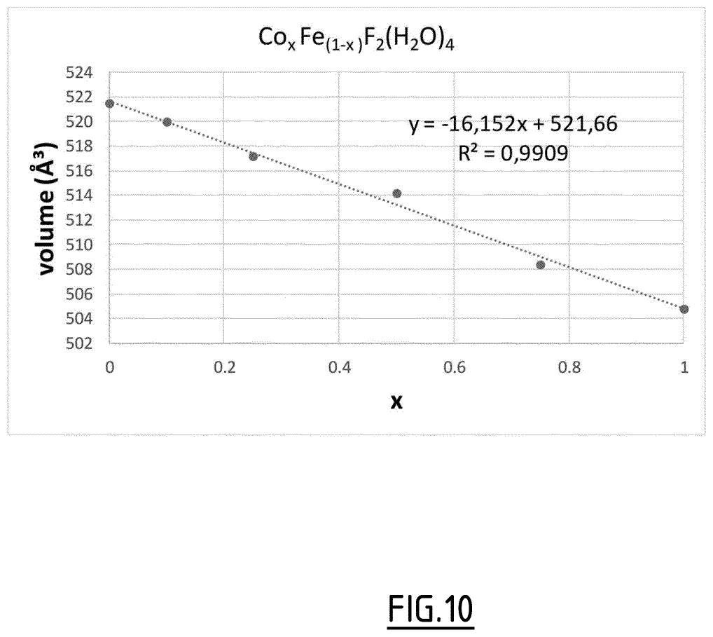

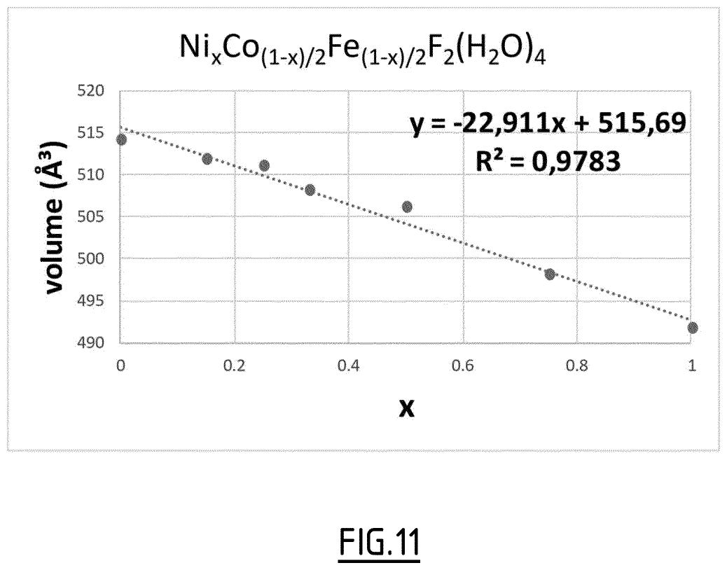

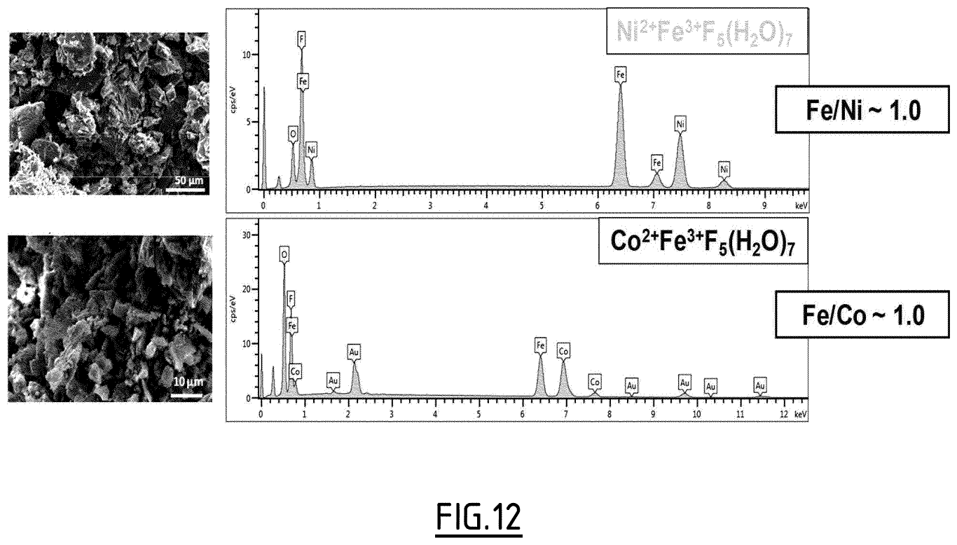

Experimental XRD patterns match with the known XRD pattern of the CoFeF₅(H₂O)₇ (PDF card number 00-037-0794) (FIG. 8). Small shifts of diffraction peaks related to different metal ionic radii are observed. The metal ratio M′³⁺/M²⁺ close to one, obtained by SEM-EDX, is in good agreement with M²⁺M′³⁺F₅(H₂O)₇ formulations (FIG. 12).

### Thermal Analyses of Co²⁺Fe³⁺F₅(H₂O)₇

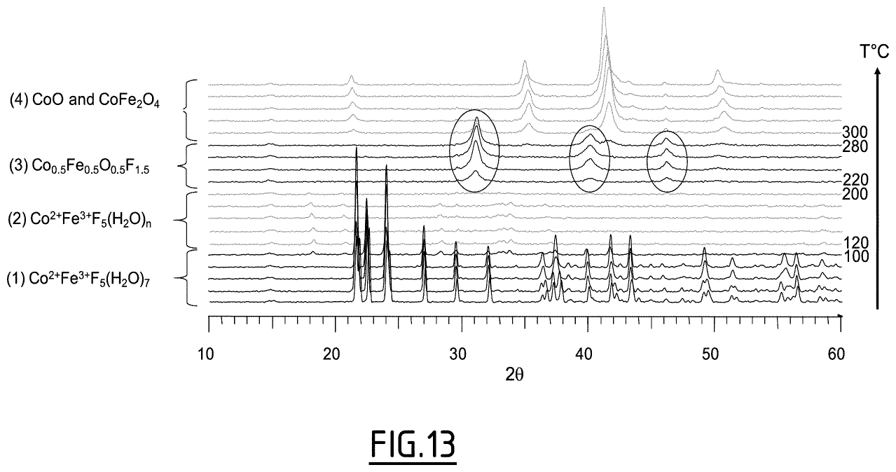

TXRD: The monitoring of the structural evolution of Co_{0.5}Fe_{0.5}O_{0.5}F_{1.5} as function of the temperature exhibits four domains (FIG. 13):
(1) RT-100° C.: stability of CoFeF₅(H₂O)₇,
(2) 100-200° C.: dehydration of CoFeF₅(H₂O)₇ leading to the formation of CoFeF₅(H₂O)ₙ (n<7),
(3) 220-280° C.: formation of Co_{0.5}Fe_{0.5}O_{0.5}F_{1.5} with rutile structure type,
(4) from 300° C.: formation of oxides CoO and CoFe₂O₄.

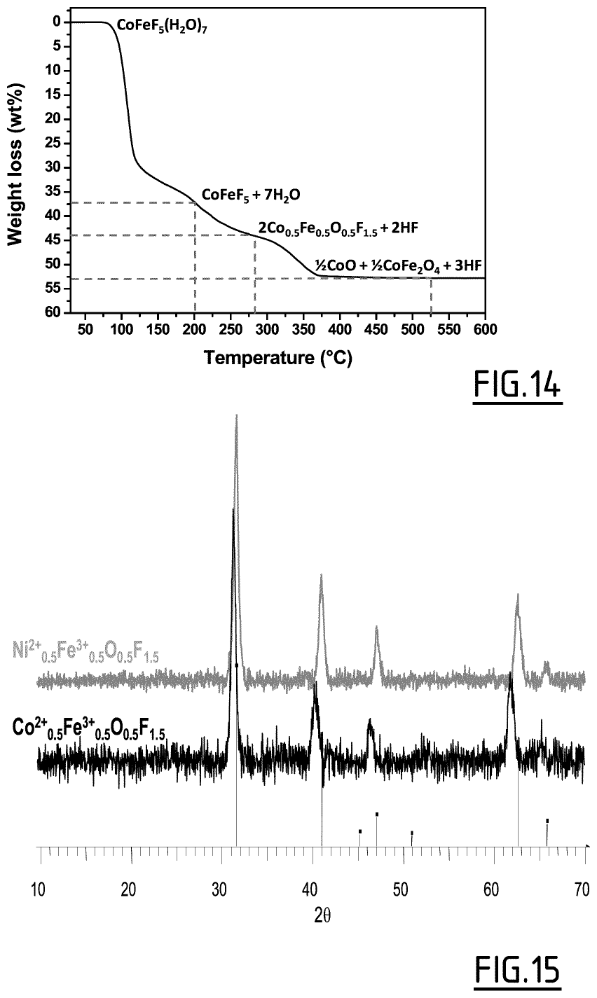

TGA: The formulation of the intermediate phase Co_{0.5}Fe_{0.5}O_{0.5}F_{1.5} observed by TDRX is confirmed by TGA under ambient air (FIG. 14). CoFeF₅(H₂O)₇ undergoes the following decompositions upon thermal treatment, the experimental weight loss values are in good agreement with theoretical values:
100° C.<T<200° C.: CoFeF₅(H₂O)₇→CoFeF₅+7H₂O (% ₜₕₑₒ=37.6%/%ₑₓₚ=37.3%)
200° C.<T<280° C.: CoFeF₅+H₂O→2Co_{0.5}Fe_{0.5}O_{0.5}F_{1.5}+2HF (%ₜₕₑₒ=43.4%/%ₑₓₚ=43.9%)
T>280° C.: 2Co_{0.5}Fe_{0.5}O_{0.5}F_{1.5}+ 3/2H₂O→½CoO+½CoFe₂O₄+3HF (%ₜₕₑₒ=53.6%/%ₑₓₚ=52.8%)

### Example 4.2: Characterization of Solid Solutions M²⁺ₓM′³⁺₁₋ₓO₁₋ₓF₁₊ₓ

XRD: XRD patterns of Co_{0.5}Fe_{0.5}O_{0.5}F_{1.5} and Ni_{0.5}Fe_{0.5}O_{0.5}F_{1.5} match with the PDF card (01-070-1522) of FeOF (rutile structure type) and show line profiles which are characteristic of low crystalline compounds (FIG. 15).

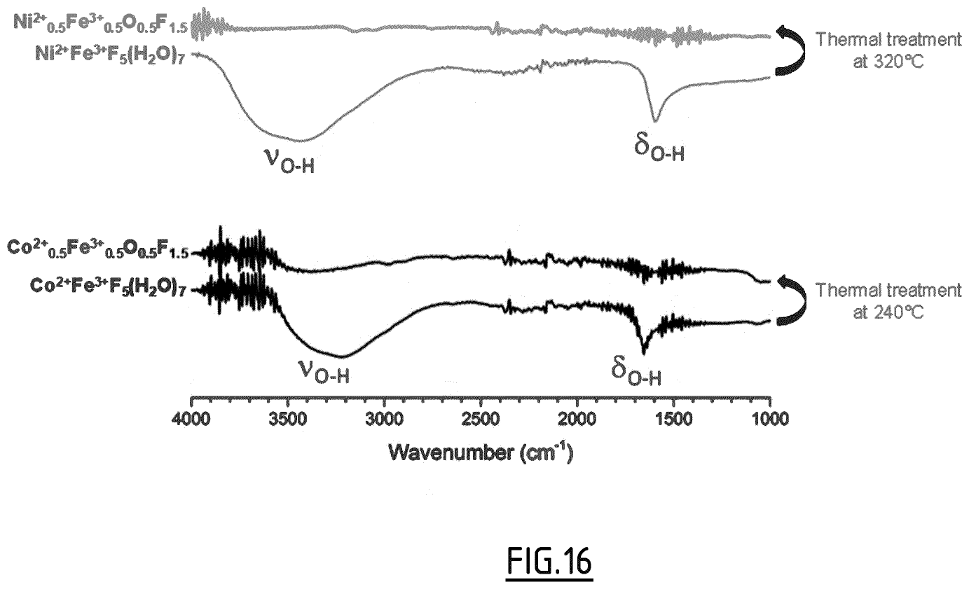

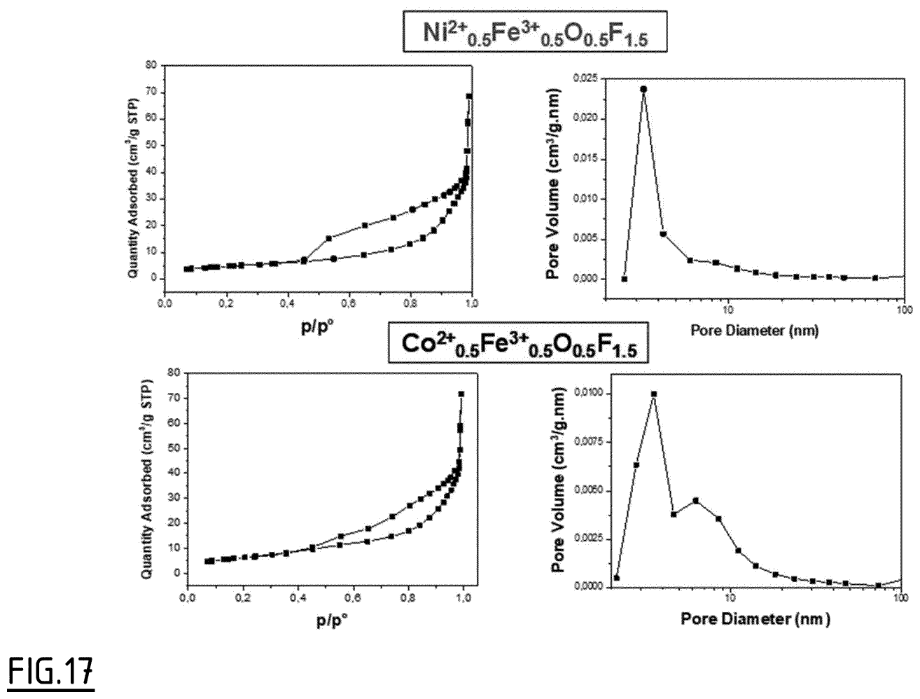

FTIR: Water removal of hydrated fluorides CoFeF₅(H₂O)₇ and CoFeF₅(H₂O)₇ after thermal treatment is confirmed by FTIR (FIG. 16). The FTIR spectra of CoFeF₅(H₂O)₇ and CoFeF₅(H₂O)₇ present a broad signal between 3300 and 2800 cm⁻¹ and a sharp peak centered at 1600 cm⁻¹ attributed to the stretching (ν_{O—H}) and bending (ν_{H—O—H}) modes respectively. After thermal treatment, these signals are no longer present, confirming H₂O removal.

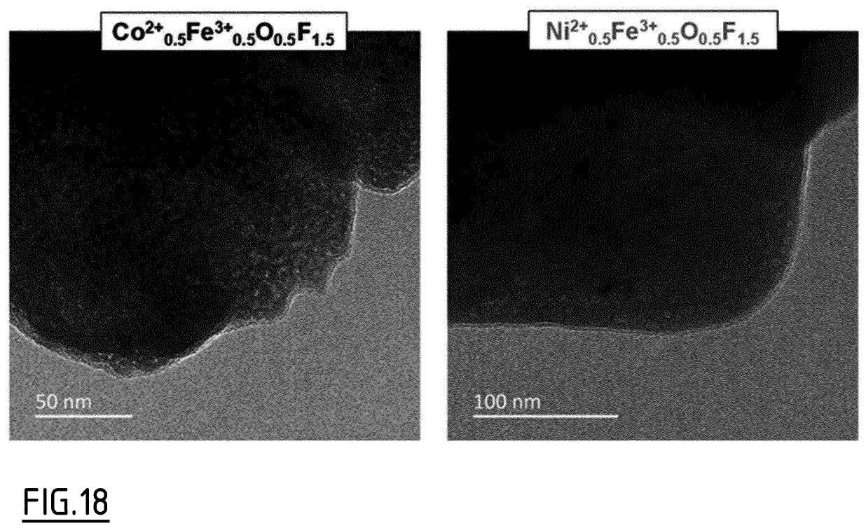

The thermal treatment induces a significant increase of the specific surface area (S_{BET}) between the hydrated fluorides and the oxyfluorides: CoFeF₅(H₂O)₇ (3 m²·g⁻¹), NiFeF₅(H₂O)₇ (1 m²·g⁻¹), Co_{0.5}Fe_{0.5}O_{0.5}F_{1.5} (24 m²·g⁻¹), and Ni_{0.5}Fe_{0.5}O_{0.5}F_{1.5} (17 m²·g⁻¹) (FIG. 17).

TEM images show that the increase of S_{BET} is probably related to an emerging porosity related to the removal of HF and H₂O gas molecules during the thermal decomposition (FIG. 18). This nanostructuration, in agreement with XRD patterns, is also confirmed by N₂ adsorption/desorption isotherms showing type IV hysteresis corresponding to mesoporous structure according to the IUPAC classification; the mesopores diameters range from 2 up to 10 nm (FIG. 17).

1. A compound of formula (I): 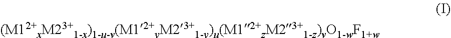
wherein
M1, M2, M1′, M2′, M1″, M2″ are transition metals of the d/f block or alkaline-earth elements in the periodic table;
u, v, x, y and z are identical or different and are such that
u+v<1;
0<x,y,z<1;
w=x+u(y−x)+v(z−x).

2. The compound according to claim 1 where M1, M1′ and M1″ belong to d/f block or alkaline-earth elements in the periodic table and M2, M2′ and M2″ belong to d/f transition elements of the periodic table.

3. The compound according to claim 1, wherein:
either x=0.5 and y=z=u=v=0 or
x=y=0.5 and u=0.5 and z=v=0 with M2=M2′ or
x=0.3 and y=0.7 and u=0.5 and z=v=0 with M2=M2′.

4. The compound according to claim 1, wherein M1 and M1′, M1″ are selected from the group consisting of Mn, Fe, Co, Ni, Cu, Zn and M2 and M2′, M2″ are chosen from Mn, Fe, Co, Ni, Ru and Rh.

5. The compound according to claim 1, wherein the compound (I) is selected from the group consisting of Co²⁺_{0.5}Fe³⁺_{0.5}O_{0.5}F_{1.5}, Ni²⁺_{0.5}Fe³⁺_{0.5}O_{0.5}F_{1.5}, Zn²⁺_{0.5}Fe³⁺_{0.5}O_{0.5}F_{1.5}, Co²⁺_{0.25}Ni²⁺_{0.25}Fe³⁺_{0.5}O_{0.5}F_{1.5}, Co²⁺_{0.15}Fe²⁺_{0.35}Fe³⁺_{0.5}O_{0.5}F_{1.5}, Co²⁺_{0.75}Fe³⁺_{0.25}O_{0.25}F_{1.75}, Ni²⁺_{0.15}Co²⁺_{0.425}Fe³⁺_{0.425}O_{0.425}F_{1.575}, Ni²⁺_{0.25}Co²⁺_{0.375}Fe³⁺_{0.375}O_{0.375}F_{1.625}, and Ni²⁺_{0.5}Co²⁺_{0.25}Fe³⁺_{0.25}O_{0.25}F_{1.75}, Ni²⁺_{0.75}Co²⁺_{0.125}Fe³⁺_{0.125}O_{0.125}F_{1.875}.

6. A solid solution of the compound according to claim 1.

7. An electrode comprising the compound of formula (I) according to claim 1 as a catalyst.

8. The electrode according to claim 7, comprising carbon paper loaded with an ink comprising the compound of formula (I).

9. An electrochemical cell comprising the electrode according to claim 7.

10. The electrochemical cell according to claim 9 which is a water electrolyzer and/or a fuel cell.

11. A process of preparation of the solid solution according to claim 6, which comprises the following steps:
synthesizing a hydrated fluorinated precursor of formula (II): 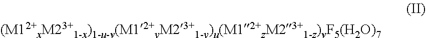
where x, y, z, u, v, M1, M2, M1′, M2′, M1″, M2″ are defined as in claim 1,
by evaporation of a concentrated hydrofluoric acid (HF) solution of the dissolved metal salts or by precipitation of said solution; and
thermally treating the compound of formula (II) at a temperature comprised between 150 and 400° C.

12. A compound of formula (II): 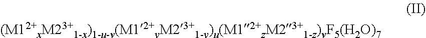
where x, y, z, u, v, M1, M2, M1′, M2′, M1″, M2″ are defined as in claim 1.

13. A process of preparation of hydrogen comprising electrolyzing water with an electrochemical cell according to claim 9.
